(19) United States
(12) Patent Application Publication
(10) Pub. No.: US 2009/0224114 A1
(43) Pub. Date: Sep. 10, 2009

(54) VERTICAL ELEVATING DEVICE OF A TABLE SAW

(76) Inventor: Bor-Yann Chuang, Taichung County (TW)

Correspondence Address: PAI PATENT & TRADEMARK LAW FIRM, 1001 FOURTH AVENUE, SUITE 3200, SEATTLE, WA, 98154, US

(21) Appl. No.: 12/043,330

(22) Filed: Mar. 6, 2008

(51) Int. Cl. F16M 11/24

(52) U.S. Cl. 248/188.4

(57) ABSTRACT

A vertical elevating device of a table saw includes an elevating base fixed on a rotating base, a main shaft mechanism, an elevating mechanism and a rotating mechanism. The elevating base includes a shaft for fixing with a round saw blade unit, an auxiliary elevating unit vertically set under the shaft and fixed on the rotating base, a guiding rod located at its two sides respectively in parallel with the auxiliary elevating unit, and a threaded guiding rod positioned at its one side and having its bottom fixed on the rotating base. The elevating mechanism is installed at one side of the rotating base, connected with the threaded guiding rod to move the elevating base up and down while whirling the elevating mechanism. With the auxiliary elevating unit focusing the support point on the gravitational center, the elevating base moves smoothly with a saved force.

### BACKGROUND OF THE INVENTION

1. Field of the Invention

This invention relates to a table saw, particularly to one having a vertical elevating device.

2. Description of the Prior Art

As shown in FIG. 1, a conventional vertical elevating device of a table saw includes an elevating base 1, a shaft 2 fixed at the center of the elevating base 1, a round saw blade unit 3 pivotally installed at the shaft 2 and driven by a pulley having its belt (not shown in the Figure) mounted between the shaft 2 and a motor (not shown in the Figure), and a main guiding rod 4 and a sub-guiding rod 5 respectively installed axially at its two ends. The main guiding rod 4 is employed to support the elevating base 1, having a larger outer diameter than that of the sub-guiding rod 5, which is used for guiding the elevating base 1. Obliquely positioned on the elevating base 1 to correspond to the main guiding rod 4 is an air cylinder 6 that is operated to provide an auxiliary pushing force while lifting the elevating base 1, and a buffering force while lowering the elevating base 1. And, a rotating base 7 is installed aside the round blade 3 for restricting the elevating base 1 positioned within the table saw.

Next, FIG. 2 is a side view of another conventional vertical elevating device of a table saw, showing a long lever arm distance (d) between the main guiding rod 4 and the sub-guiding rod 5, so that it is far from the gravitational center of the central axis (a) of the elevating base 1. And, as the main force of supporting the elevating base 1 comes from the main guiding rod 4 instead of the gravitational center of the central axis (a) of the elevating base 1, the gravitational center of the elevating base 1 is so easily deviated that a copper washer 8 has to be installed at the upper portion and the lower portion of the main guiding rod 4 respectively, employed to adjust the gap between the main guiding rod 4 and the elevating base 1 to keep its support point located on the copper washers 8. Moreover, an air cylinder 6 is obliquely installed to be positioned out of the central axis (a) of the elevating base 1, apt to split its force to make the elevating base 1 unable to be effectively balanced.

### SUMMARY OF THE INVENTION

The objective of this invention is to offer a vertical elevating device of a table saw.

The characteristics of the invention are a rotating base, an elevating base, a main shaft mechanism, an elevating mechanism and a rotating mechanism. The elevating base includes a shaft positioned at its central axis for pivotally fixing with a round saw blade unit, an auxiliary elevating unit vertically set under the shaft to coincide with the central axis of the elevating base and fixed on the rotating base, a guiding rod located at its two sides respectively in parallel with the elevating auxiliary unit, and a threaded guiding rod positioned at its one side and having its bottom fixed on the rotating base. An elevating mechanism is installed at one side of the rotating base, connected with the threaded guiding rod so as to enable the elevating base to move up and down while whirling the elevating mechanism. With help of the auxiliary elevating unit to keep its support point focused on the gravitational center, the elevating base can be kept well balanced to move smoothly with a saved force.

### BRIEF DESCRIPTION OF DRAWINGS

This invention is better understood by referring to the accompanying drawings, wherein:

FIG. 1 is a side perspective view of a conventional vertical elevating device of a table saw;

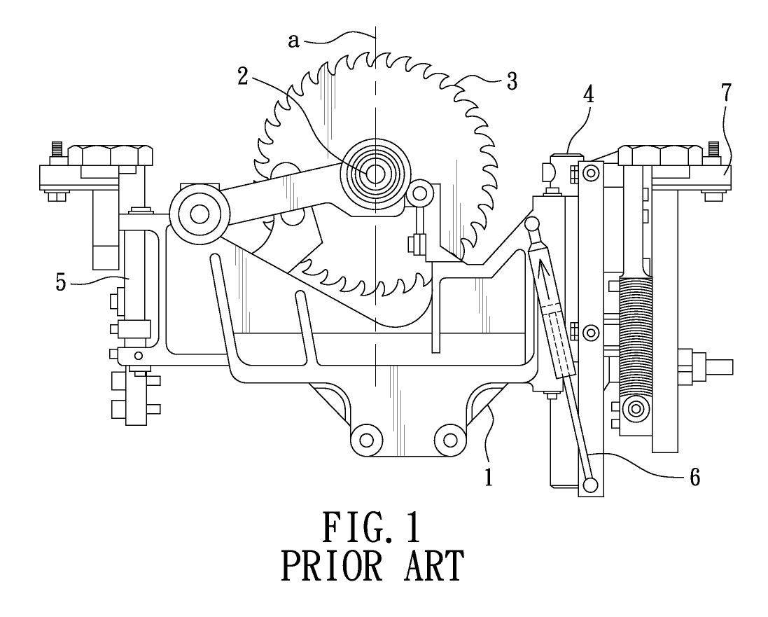

FIG. 2 is a simple illustration of the conventional vertical elevating device of a table saw, showing it being operated;

FIG. 3 is a perspective view of a preferred embodiment of a vertical elevating device of a table saw in the present invention, showing it being installed in the main body of a table saw;

FIG. 4 is a perspective view of the preferred embodiment of a vertical elevating device of a table saw in the present invention;

FIG. 5 is an exploded perspective view of the preferred embodiment of a vertical elevating device of a table saw in the present invention;

FIG. 6 is a side perspective view of the preferred embodiment of a vertical elevating device of a table saw in the present invention, showing it under operation; and

FIG. 7 is a side view of the preferred embodiment of a vertical elevating device of a table saw in the present invention, showing it being operated.

### DETAILED DESCRIPTION OF THE PREFERRED EMBODIMENT

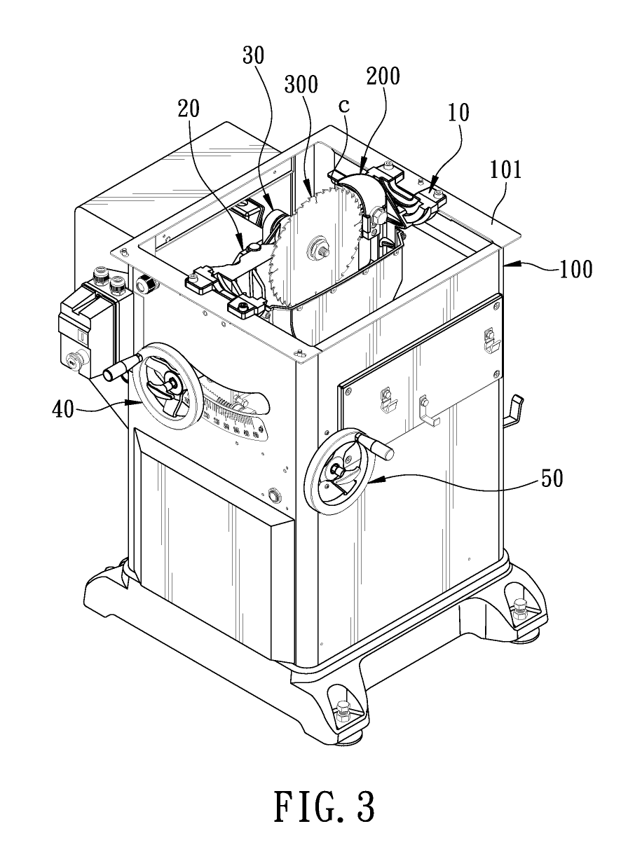

FIG. 3 is a perspective view of a preferred embodiment of a vertical elevating device of a table saw in the present invention, showing it being pivotally installed in a table 101 of a main body 100 of a table saw. And, the vertical elevating device is to be assembled together with a blade guard 200 and a round saw blade unit 300 to enable them to extend above the table 101 to carry out sawing with a thickness properly adjusted. Meanwhile, a gap (c) is maintained between the blade guard 200 and the round saw blade unit 300 while being lifted up or lowered down. The vertical elevating device in the present invention includes a rotating base 10, an elevating base 20, a main shaft mechanism 30, an elevating mechanism 40 and a rotating mechanism 50.

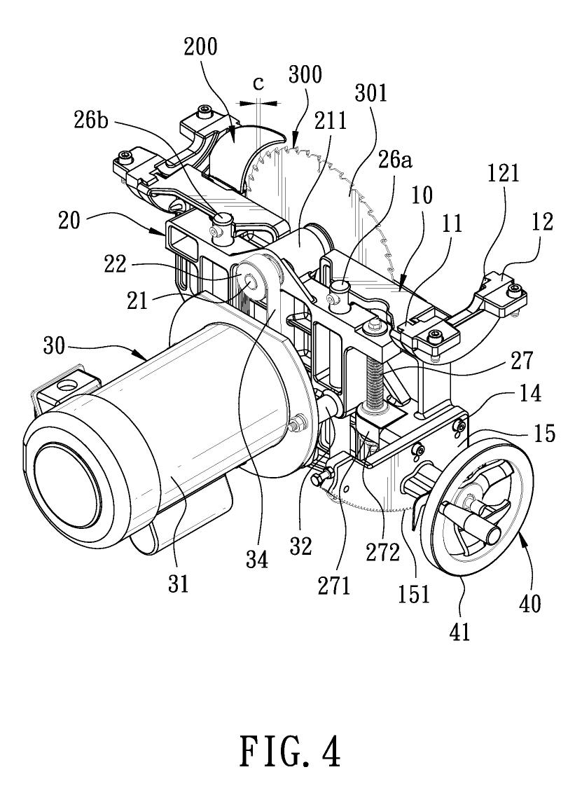

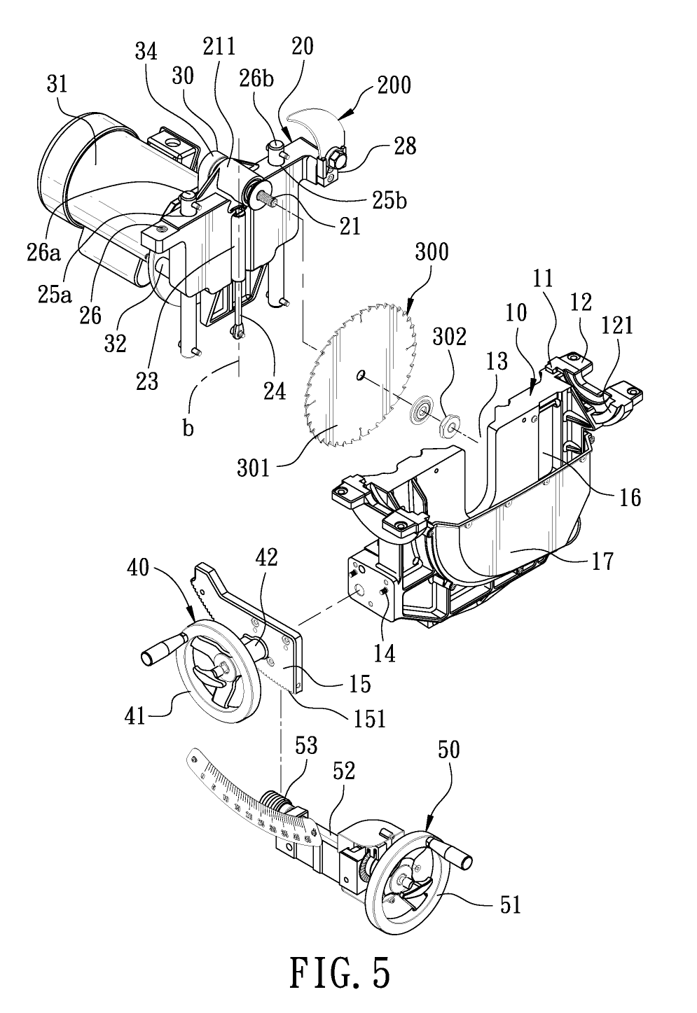

The rotating base 10, with reference to FIGS. 4 and 5, is formed semi-circular, provided with a connecting groove 11 formed at the top of its two sides respectively for being mounted on a U-shaped sliding rail 121 of a U-shaped base 12, by which the rotating base 10 is installed at two corresponding sides of the main body 100. The rotating base 10 is also provided with an elevating groove 13 cut at its central upper portion with an opening facing upward, three screws 14 used to fix a sector gear 15 on the lower portion of its left side, and a rectangular slot 16 formed in the upper portion of its right side. The sector gear 15 has teeth 151 formed along its lower edge. And, a cover 17 shaped similar to the rotating base 10 is assembled aside and appropriately spaced apart the rotating base 10 for a dust-proof purpose.

The elevating base 20 is installed at the inside of the rotating base 10, provided with a shaft 21 positioned at its central axis (b) to transversely rest on the center of the opening of the elevating groove 13. The shaft 21 has its intermediate portion mounted with a sleeve 211, its rear end linked with a pulley 22, and its front end extended out of the rotating base 10 for pivotally fixed with the round saw blade unit 300, with a nut 302 engaged with the shaft 21 to keep a round blade 301 restrictively positioned between the outside of the rotating base 10 and the cover 17. Vertically located along the central axis (b) of the elevating base 20 and below the shaft 21 is an auxiliary elevating unit 23, which is an air cylinder filled with nitrogen to enable a reciprocating rod 24 axially fitted in the air cylinder to reciprocate for buffering. The reciprocating rod 24 has its bottom end fixed at the inside of the rotating base 10 to keep the auxiliary elevating unit 23 positioned at the gravitational center of the elevating base 20 and the rotating base 10. In addition, the elevating base 20 is as well provided with two guiding holes 25a and 25b vertically bored at two sides of the central axis (b) in parallel with the elevating auxiliary unit 23, two guiding rods 26a and 26b respectively inserted in the guiding holes 25a and 25b and having their top end and their bottom end fixed on the rotating base 10 to be positioned inside the round blade 301, and a threaded guiding hole 26 vertically bored next to the guiding hole 25a.

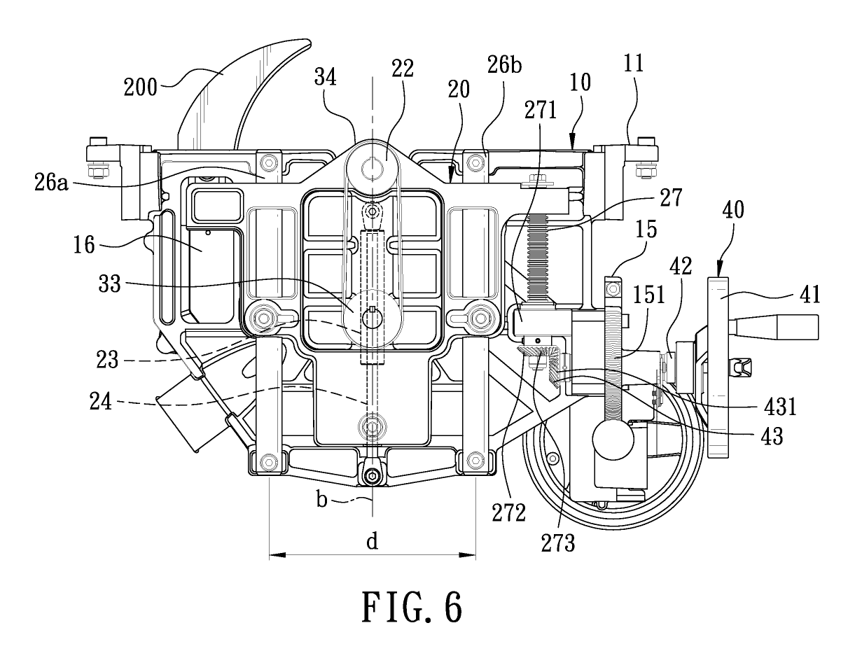

And, as shown in FIG. 6 that is a perspective side view of the vertical elevating device, a threaded guiding rod 27 is engaged with the threaded guiding hole 26, provided with a positioning base 271 engaged around its bottom portion and having its one side fixed on the rotating base 10, and a driven bevel gear 272 transversely fixed at the bottom of the positioning base 271 and formed with teeth 273 around the circumference. With reference to FIGS. 4 and 5 again, a blade guard base 28 is installed at one side of the elevating base 20 near the guiding hole 25b to extend through the rectangular slot 16 of the rotating base 10 to stay between the rear side of the rotating base 10 and the cover 17, used to fixedly position the collapsible blade guard 200. The blade guard 200 is formed as an arc corresponding to the circumference of the round blade 301, enabling itself to be spaced apart with the round blade 301 by a gap (c) while being adjusted and fixed by the blade guard base 28.

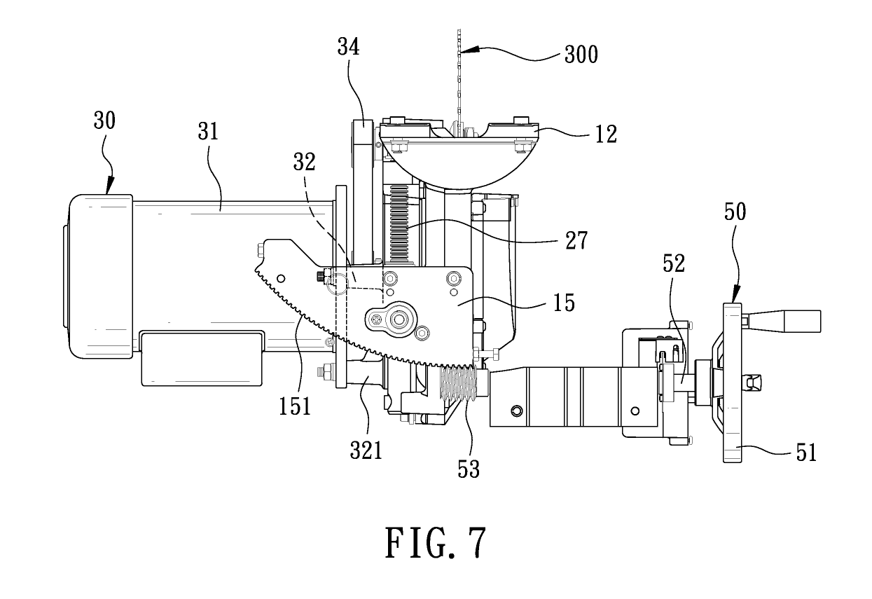

The main shaft mechanism 30, as shown in FIGS. 4 and 5, is positioned outside the elevating base 20 to exactly coincide with the central axis (b), moving up and down along with the elevating base 20. The main shaft mechanism 30 is provided with a motor 31 transversely located in parallel with the shaft 21, and a pulley 33 fixed at the central shaft of the motor 31. Mounted on the pulley 22 of the shaft 21 and the pulley 33 of the motor 30 is an endless driving belt 34 utilized to drive the round blade 301 to whirl. Referring to FIG. 7, a top view of the vertical elevating device, the motor 31 is fixed on the elevating base 20 by means of a first bar 32 located at two sides of the motor 31 respectively and a second bar 321 located at the central bottom of the motor 31.

The elevating mechanism 40, as shown in FIG. 6, is installed under the threaded guiding rod 27, provided with a first rotary wheel 41, a first driving rod 42, and a driving bevel gear 43 formed around the end of the first driving rod 42. The first driving rod 42 is inserted through the sector gear 15 to reach the bottom of the threaded guiding hole 27, fixed with the sector gear 15. The driving bevel gear 43 is provided with teeth 431 for engaging with the teeth 273 of the driven bevel gear 272.

The rotating mechanism 50, as shown in FIGS. 5 and 7, is assembled under the sector gear 15, including a second rotary wheel 51, a second driving rod 52, and a worm 53 formed around the end portion of the second driving rod 52 for engaging with the teeth 151 of the sector gear 15.

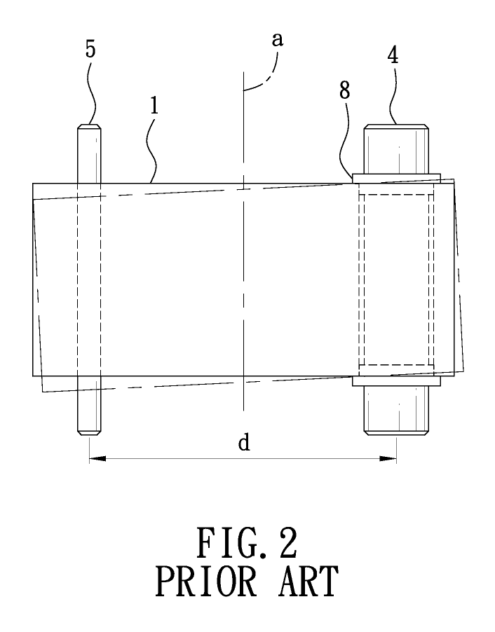

In using, as shown in FIG. 6, when the round saw blade unit 300 is to be lifted up to a proper position for cutting a piece of wood, the elevating mechanism 40 has to be clockwise rotated to make the teeth 431 of the driving bevel gear 43 engaged with the teeth 273 of the driven bevel gear 271 of the threaded guiding rod 27, so that the threaded guiding rod 27 can be driven to immovably whirled to enable the threaded guiding hole 26 moved up to simultaneously raise up the elevating base 20. By the time, the gas compressed in the auxiliary elevating unit 23 is to be gradually decompressed to push the reciprocating rod 24 to gravitationally help the elevating base 20 moving up along the guiding rods 26a and 26b vertically, so as to simultaneously lift up the main shaft mechanism 30 to enable the round saw blade unit 300 to carry out sawing. As the guiding rods 26a and 26b are positioned close to the gravitational center of the elevating base 20 to have a lever arm distance (d) between them shorter than that of the conventional vertical elevating device shown in FIG. 2, torque is shrunk to make the pushing force intensified on the central axis (b) of the elevating base 20, achieving a good structural rigidity to keep the elevating base 20 well balanced without biasing while lifted up, obtaining a purpose of saving force.

On the contrary, in case the elevating base 20 is to be lowered down, the elevating mechanism 40 has to be counterclockwise rotated to likewise make the teeth 431 of the driving bevel gear 43 engaged with the teeth 273 of the driven bevel gear 271 of the threaded guiding rod 27. By the time, the gas in the elevating auxiliary unit 23 is compressed to keep the elevating base 20 steadily lowered, and the main shaft mechanism 30 is synchronously moved down. In addition, as shown in FIG. 7, when the cutting angle is to be shifted, the rotating mechanism 50 has to be turned around to keep the worm 53 engaged with the teeth 151 of the sector gear 15 to enable the rotating base 10 to whirl for consecutively driving the elevating base 20 to bias, with a help of the elevating auxiliary unit 23.

The advantages of the invention are described below as can be seen from the foresaid description. With the auxiliary elevating unit 23 and the pivot positioned at the central axis (b) of the elevating base 20 to help the elevating base 20 vertically moving along the guiding rods 26a and 26b that are installed close to the inside of the central axis (b) of the elevating base 20 and parallel to the auxiliary elevating unit 23, the lever arm distance (d) between the guiding rods 26a and 26b is thus shorter than that of the conventional vertical elevating device, resulting in a shrunk torque to relatively have an intense pushing force and a good structural rigidity, so as to keep the elevating base 20 well balanced without deviation while lifted up for achieving a smooth operation and a purpose of saving force.

While the preferred embodiment of the invention has been described above, it will be recognized and understood that various modifications may be made therein and the appended claims are intended to cover all such modifications that may fall within the spirit and scope of the invention.

What is claimed is:

1. A vertical elevating device of a table saw comprising a rotating base, an elevating base installed at an inside of said rotating base, a main shaft mechanism fixed at an outside of said rotating base, a shaft transversely positioned at an central axis of said elevating base and connected with said main shaft mechanism, said rotating base provided with an elevating groove axially cut at its central portion with an opening facing upward for being mounted by said shaft that is to be pivotally fixed with a round saw blade unit to carry out sawing, said elevating base having a threaded guiding rod located at its one side and having its bottom fixed with said rotating base, an elevating mechanism installed at one side of said rotating base and connected with said threaded guiding rod to drive said elevating base to move up and down, said vertical elevating device characterized by:
Said elevating base provided with an auxiliary elevating unit vertically installed along its central axis and under said shaft, said auxiliary elevating unit having its bottom fixed on said rotating base, a guiding rod vertically positioned at two sides of said elevating base respectively in parallel with said elevating auxiliary unit, each of said guiding rods having its top and its bottom fixed on said rotating base, said auxiliary elevating unit able to help said elevating base restrictively moving along said guiding rods to keep a support point concentrated inside a gravitational center of said elevating base to enable said elevating base to smoothly move with a saved force.

2. The vertical elevating device of a table saw as claimed in claim 1, wherein said auxiliary elevating unit is an air cylinder.

3. The vertical elevating device of a table saw as claimed in claim 1, wherein said rotating base is provided with a connecting groove formed at a top of its two sides respectively for being mounted on a U-shaped sliding rail of a U-shaped base that is installed at two corresponding sides of a main body respectively, a sector gear installed under said rotating base and fixed on said rotating base by means of plural screws.

4. The vertical elevating device of a table saw as claimed in claim 1, wherein said threaded guiding rod has its lower portion engaged with a positioning base having its one side fixed on said rotating base, and a driven bevel gear is located below said positioning base.

5. The vertical elevating device of a table saw as claimed in claim 1, wherein said main shaft mechanism includes a motor, a pulley set at a center of said motor for being mounted by a belt that is also mounted on said shaft to drive said round saw blade unit to rotate.

6. The vertical elevating device of a table saw as claimed in claim 1, wherein said elevating mechanism is installed below said threaded guiding rod and provided with a first rotary wheel, a first driving rod horizontally connected with said first rotary wheel, a driving bevel gear vertically fixed at a bottom of said first driving rod to engage with said driven bevel gear of said elevating base.

7. The vertical elevating device of a table saw as claimed in claim 3, wherein a rotating mechanism is installed below said sector gear and provided with a second rotary wheel, a second driving rod horizontally connected with said second rotary wheel, a worm fixed at an end of said second driving rod to engage with said sector gear.

8. The vertical elevating device of a table saw as claimed in claim 1, wherein said motor is fixed on said elevating base by two first bars respectively positioned at two sides of said motor and a second bar positioned at a bottom of said motor.
